(19) United States
(12) Patent Application Publication
(10) Pub. No.: US 2017/0329780 A1
(43) Pub. Date: Nov. 16, 2017

(54) Collection-Based Searches Along a Route

(71) Applicant: Microsoft Technology Licensing, LLC, Redmond, WA (US)

(72) Inventor: Elizabeth Picchietti Salowitz, Seattle, WA (US)

(73) Assignee: Microsoft Technology Licensing, LLC, Redmond, WA (US)

(21) Appl. No.: 15/151,178

(22) Filed: May 10, 2016

(51) Int. Cl. G06F 17/30

(52) U.S. Cl. CPC G06F 17/3053; G06F 17/30061

(57) ABSTRACT

Collection-based searches along a route are described herein. In one or more implementations, a mapping application is configured to conduct point-of-interest (POI) searches along a route in dependence upon information from collections associated with the user to inform the search results. For instance, the mapping application may cross-reference collections and adjust POI rankings to favor items identified from the collections. The searches along a route may also be focused upon the user's own collections, shared collections, group collections, or other user-specific collections to find items that match the search criteria. By way of the example, the user-specific collections may include lists of favorites items that are shared with the user by friends, and/or group lists generated via social networks. Incorporating the user-specific collections in searches along a route allows for more personalized and customized experience since the search results are generated using customized items included in the collections.

### BACKGROUND

Use of navigation assistance technology to help individuals get from one place to another is widespread. For instance, automobiles, mobile phones, and even wrist watches may include navigation functionality to provide maps, directions, and searches for points of interest (POIs). The navigation assistance technologies allow users to plan trips, obtain directions and even provide updates regarding a user's location while travelling. Navigation assistance technologies may also enable users to “search along a route” for POIs (e.g., gas, restaurant, park, hotel, etc.) in connection with a planned route between start and end points. Traditionally, searches along a route rely upon an established and/or fixed set of POIs used across different users, such as a collective POI database curated by a service provider. Places matching particular search criteria are identified with reference to the collective POI database, ranked one to another, and top ranking items are exposed as results of the search. In this approach, the search results are constrained to places that the service provider includes in the database without adjusting the set of POIs or ranking the results differently for different individuals.

### SUMMARY

Collection-based searches along a route are described herein. In one or more implementations, a mapping application is configured to conduct point-of-interest (POI) searches along a route in dependence upon items from collections associated with the user to inform the search results. For instance, the mapping application may cross-reference user-specific collections and adjust POI rankings to favor items identified from the collections. The searches along a route may also be focused exclusively upon the user's own collections, shared collections, group collections, and other user-specific collections to find items that match the search criteria. By way of example, the user-specific collections may include lists of favorites items that are shared with the user by others and/or group lists generated via social networks. Incorporating the user-specific collections in searches along a route enables a more personalized and customized experience since the search results are generated using user-specific items included in the collections.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is a diagram depicting an example configuration of a map navigation tool in accordance with one or more implementations.

FIG. 3 is a diagram depicting an example scenario for a search along a route using user collections in accordance with one or more implementations.

FIG. 4 is a diagram depicting details of an example user interface presenting search results in accordance with one or more implementations.

FIG. 5 is flow diagram depicting an example procedure for a collection-based search in accordance with one or more implementations.

FIG. 6 is flow diagram depicting another example procedure for a collection-based search in accordance with one or more implementations.

FIG. 7 illustrates an example system including various components of an example device that can be employed for one or more implementations of the techniques described herein.

### DETAILED DESCRIPTION

### Overview

Traditionally, searches along a route rely upon an established and/or fixed set of POIs used across different users, such as a collective POI database curated by a service provider. In this approach, the search results are constrained to places that the service provider includes in the database without adjusting the set of POIs or ranking the results differently for different individuals. Consequently, the search results are not tailored to provide users with a personalized and customized experience.

Techniques for collection-based searches along a route are described herein. In one or more implementations, a mapping application is configured to conduct point-of-interest (POI) searches along a route in dependence upon information from collections associated with the user to inform the search results. For instance, the mapping application may cross-reference collections and adjust POI rankings to favor items identified from the collections. In operation, points corresponding to the known route (represented as a set of lat/long points for the user to travel along) are derived and a search is conducted within a region around those points based on input search criteria (e.g., nearest gas station, search for Albertson's, recommend hotel, etc.). The search algorithm is configured to check user-specific collections to identify items in the collections located along the route that match the search criteria. Items within the collections are then included within the search results. Items from user-specific collections may be presented along with POIs from other sources such as a collective POI database. Items obtained for the user-specific collections may be visually distinguished from POIs from other sources within a list, map views, and so forth. Criteria used to rank results may also be adjusted to favor items contained in user-specific collections. The searches along a route may also be focused upon user-specific collections such that results matching the search criteria are obtained exclusively from the collections.

By way of the example, the user-specific collections may include lists of favorites items that are shared with the user by friends, and/or group lists generated via social networks. The user-specific collections may also include favorites items that the user publishes or shares with others. The user-specific collections may further include community-based collections (e.g., recommendation databases) that the user subscribes to or otherwise designates as collections to use for to facilitate navigation and mapping activities. Incorporating the user-specific collections in searches along a route allows for more personalized and customized experience since the search results are generated using user-specific items included in the collections.

In the following discussion, an example environment is first described that may employ the techniques described herein. Example procedures and implementation details are then described which may be performed in the example environment as well as other environments. Consequently, performance of the example procedures and details is not limited to the example environment and the example environment is not limited to performance of the examples procedures and details.

### Example Environment

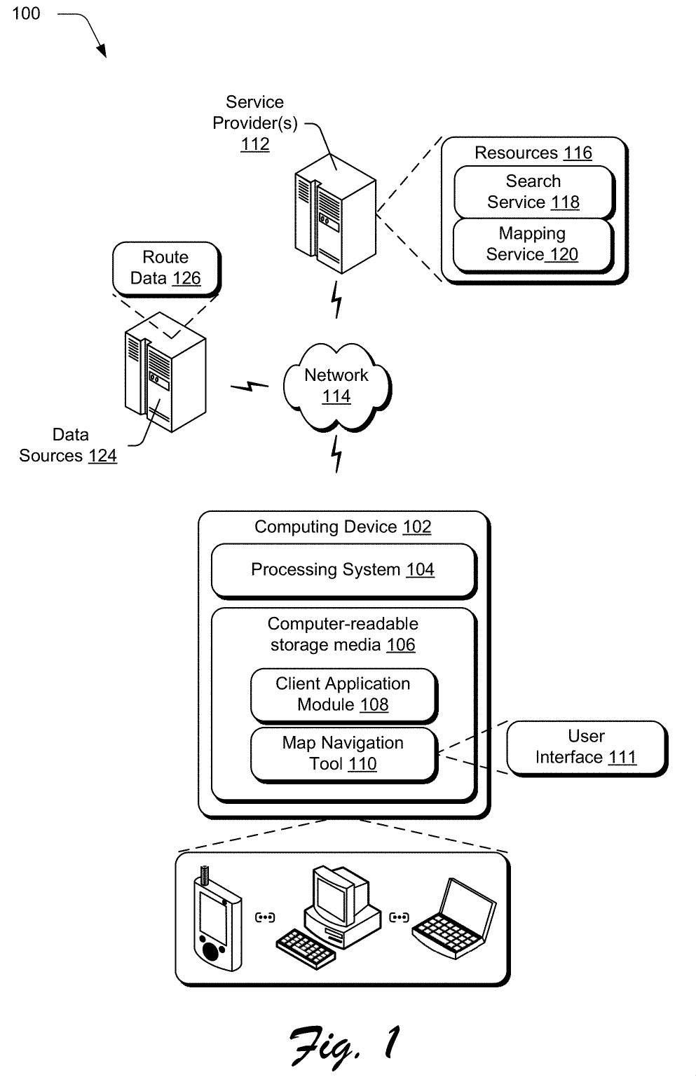

FIG. 1 is an illustration of an environment 100 in an example implementation that is operable to employ techniques described herein. The illustrated environment 100 includes a computing device 102 including a processing system 104 that may include one or more processing devices, one or more computer-readable storage media 106 and a client application module 108 embodied on the computer-readable storage media 106 and operable via the processing system 104 to implement corresponding functionality described herein. In at least some embodiments, the client application module 108 may represent a browser of the computing device operable to access various kinds of web-based resources (e.g., content and services). The client application module 108 may also represent a client-side component having integrated functionality operable to access web-based resources (e.g., a network-enabled application), browse the Internet, interact with online services, and so forth.

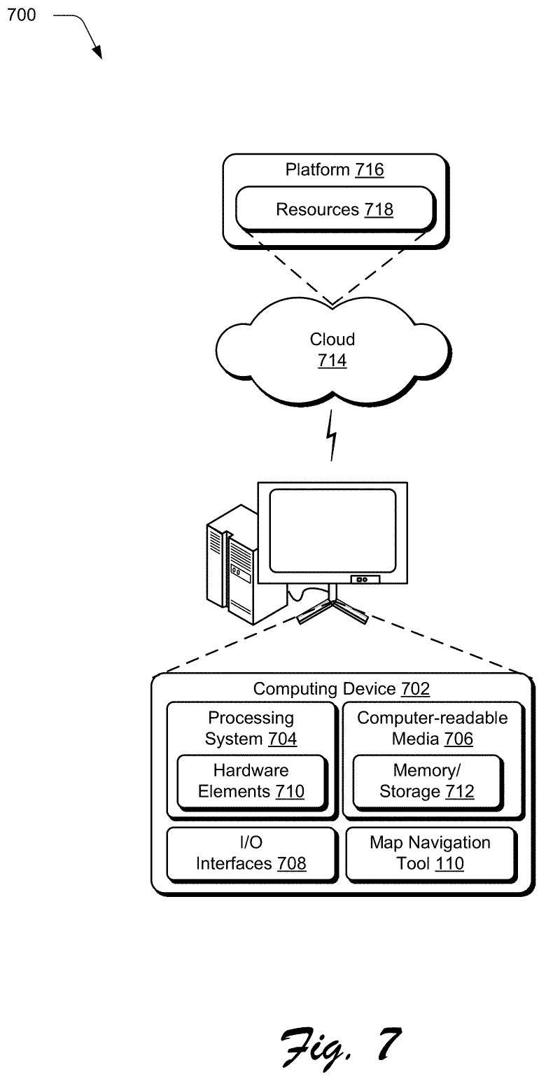

The computing device 102 may be configured as any suitable type of computing device. For example, the computing device may be configured as a desktop computer, a laptop computer, a mobile device (e.g., assuming a handheld configuration such as a tablet or mobile phone), a tablet, and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 7.

The computing device 102 may also include or make use of a map navigation tool 110 that represents functionality operable to implement techniques related to mapping as described above and below, including but not limited to navigation, route searches, point of interest searches, and other mapping operations. The map navigation tool 110 may be implemented as a software module, a hardware device, or using a combination of software, hardware, firmware, fixed logic circuitry, etc. The map navigation tool 110 may be implemented as a standalone component of the computing device 102 as illustrated. In addition, or alternatively, the map navigation tool 110 may be configured as a component of the client application module 108, an operating system, or other device application. For example, map navigation tool 110 may be provided as a plug-in and/or downloadable script for a browser. Map navigation tool 110 may also represent script contained in or otherwise accessible via a webpage, web application, or other resources made available by a service provider.

In accordance with techniques described herein, the map navigation tool 110 is operable to access and utilize various available services and sources of data to facilitate navigation and mapping activities. For instance, the map navigation tool 110 performs operations to access device location data, obtain map data, generate maps, compute routes, provide navigational information, conduct searches based on input criteria, rank and output search results, and so forth. Maps, search results, route views, and other outputs generated via the map navigation tool 110 may be exposed via a user interface 111 output by the map navigation tool 110, or output by another application for which the map navigation tool 110 is configured to provide functionality for mapping and navigation.

The map navigation tool 110 is further configured to conduct point-of-interest (POI) searches along a route in dependence upon information from collections associated with the user to inform the search results. For instance, the map navigation tool 110 may cross-reference collections and adjust POI rankings to favor items identified from the collections and include items from collections in search results along with other POIs. The searches along a route may also be focused upon the user's own collections, shared collections, group collections, or other user-specific collections to find items that match the search criteria.

The environment 100 further depicts one or more service providers 112, configured to communicate with computing device 102 over a network 114, such as the Internet, to provide a “cloud-based” computing environment. Generally, speaking a service provider 112 is configured to make various resources 116 available over the network 114 to clients. In some scenarios, users may sign-up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services and/or content typically made available over a network by one or more providers. Some examples of services include, but are not limited to, a photo editing service, a web development and management service, a collaboration service, a social networking service, a messaging service, an advertisement service, and so forth. Content may include various combinations of text, video, ads, audio, multi-media streams, animations, images, web documents, web pages, applications, device applications, data APIs, and the like.

By way of example, the service provider is illustrated as including a search service 118 and a mapping service 120. The map navigation tool 110 is configured to invoke the search service 118 and/or mapping service 120 to perform searches along a route using user collections as described above and below. The search service 118 may operate to conduct searches based on specified criteria. The search service 118 includes functionality to search across various data sources and collections to find and return results that match specified search criteria. The search service 118 is further configured to perform searches related to navigation and mapping including searches for directions, POIs, and so forth. The mapping service 120 represents functionality operable to access and obtain navigation and mapping data including map views, route information, distances, waypoint, navigation instructions, and so forth. The search service 118 and mapping service 120 may each access and rely upon data from various data sources 124 including various different resources associated with service provider and/or resources made accessible via third party providers. Such data may include route data 126 as illustrated. The data sources 124 may additionally provide access to collections, social network data, POI data, map data/services, and other data that may be used to generate search results and navigation/mapping data for use by clients in connection with collection-based searches along a route or otherwise.

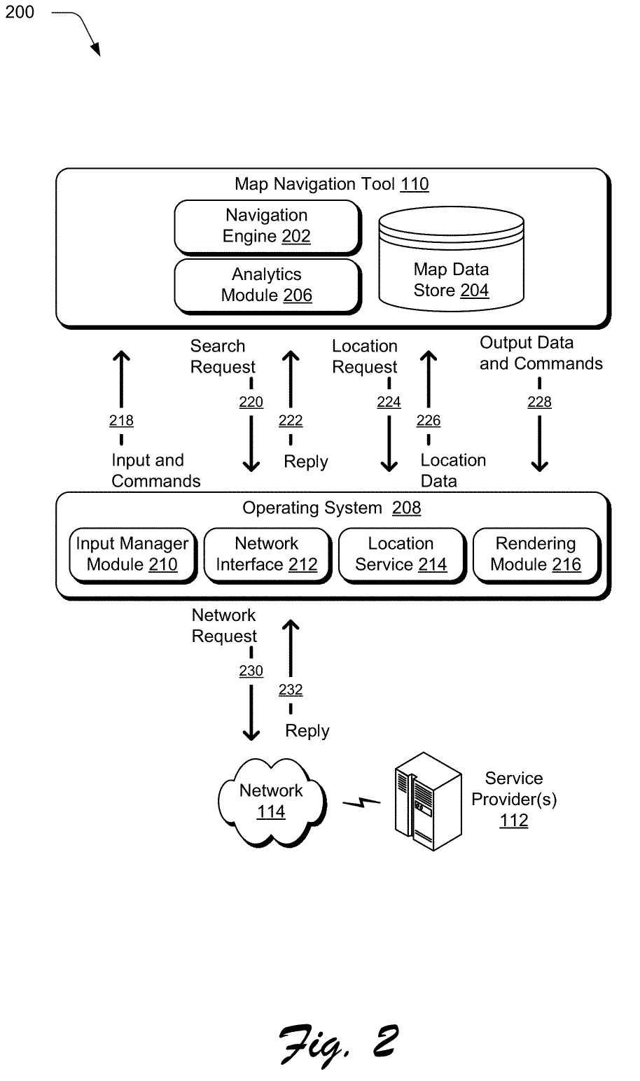

In this context, FIG. 2 depicts generally at 200 an example configuration of a map navigation tool 110 in accordance with one or more implementations. In this example, the map navigation tool 110 includes a navigation engine 202, map data store 204, and analytics module 206 operable in conjunction with an operating system 208 to provide navigation and mapping functionality. A client computing device (e.g., smartphone, mobile device or other computing device 102) can execute software for the map navigation tool 110 and the operating system 208 to provide various navigation/mapping functionality including at least collection-based searches along a route as discussed in this document.

The operating system 208 manages user input functions, output functions, storage access functions, network communication functions, and other functionality for the device. The operating system 208 provides the map navigation tool 110 access to such functions through various components and interfaces. For instance, the operating system 208 includes an input manager module 210 for input processing, a network interface 212 for networking, a location service 214 for location tracking through GPS or otherwise, and a rendering module 216 for rendering outputs (e.g., rendering visual output to a display, generating voice output for a speaker).

A user can generate user input that specifies and controls map navigation. In particular, input manager module 210 represents functionality to obtain and process various types of input including touchscreen input, button or key presses and voice input. Thus, the OS includes functionality for recognizing taps, finger gestures, etc. to a touchscreen from tactile input, recognizing commands from voice input, button input or key press input, and creating signals/messages to control and direct operation of the map navigation tool 110 and/or other software. Input and commands 218 generated based on detected input are conveyed to the map navigation tool 110 for handling via the navigation engine 202.

The navigation engine 202 represents functionality to implement various navigation and mapping operations. The navigation engine 202 may rely upon cached map data and/or map database that is stored locally in the map data store 204. The navigation engine 202 may also invoke the analytics module 206 to perform analysis including input interpretation, ranking and sorting of search results, generation of navigation instruction, route calculation, and so forth. Further, the navigation engine 202 in conjunction with the analytics module 206 provides functionality to form search requests 220 and obtain replies 222. The search requests 220 may be directed to appropriate network resources and servers via the network interface 212. Additionally, the navigation engine 202 may form location requests 224 and obtain location data 226 from the location service 214 based on the requests. The location data is used to inform navigation and mapping operations, such as showing a current position, computing distances, routing calculations, and so forth.

For navigation, the navigation engine 202 considers a current view position and any input that indicates a desired change in the view position, map data and location data. From this information, the navigation engine 202 determines a view position and provides the view position as well as location data and map data in the vicinity of the view position for rendering via the rendering module 216. In particular, the navigation engine 202 sends output data and commands 228 to direct operation of the rendering module 216 to cause corresponding output via a user interface 111, or otherwise. The location data 226 indicates a current location (of the computing device 102) that aligns with the view position, or the view position can be offset from the current location. The navigation engine 202 gets current location data for the computing device from the location service 214, which may determine the current location data through interaction with various components of the computing device. For example, the location data can be determined based upon data from a global positioning system (GPS), by triangulation between towers of a cellular network using cellular hardware, by reference to physical locations of Wi-Fi routers in the vicinity via a Wi-Fi radio, or by another location mechanism.

As noted, the navigation engine 202 can obtain at least some map data for a map from a map data store 204. In general, the map data can include photographic image data or graphical data (for boundaries, roads, etc.) at various levels of detail, ranging from high-level depiction of states and cities, to medium-level depiction of neighborhoods and highways, to low-level depiction of streets and buildings. Aside from photographic data and graphical data, the map data can include graphical indicators such as icons or text labels for place names of states, cities, neighborhoods, streets, buildings, landmarks or other features in the map. Additionally, the map data can also include distances between features, route points (in terms of latitude and longitude) that define a route between start and destination points, text directions for decisions at waypoints along the route (e.g., turn at Sandy Shores, Ln), and distances between waypoints along the route. The map data can provide additional details for a given feature such as contact information (e.g., phone number, Web page, address), reviews, ratings, other commentary, menus, photos, advertising promotions, or information for games (e.g., geo-caching, geo-tagging). Links can be provided for Web pages, to launch a Web browser and navigate to information about the feature. The map data store 204 may be configured to cache recently used map data and/or maintain a local map library. As needed, the map data store 204 accesses additional or updated map data from local file storage or from network resources. The OS mediates access to the storage and network resources.

For example, to determine directions for a route, the map navigation tool 110 ascertains a start point (typically, the current location of the computing) and an end point for a destination (e.g., an address or other specific location) as part of a request for map data. The device OS conveys the request over a network 114 as a network request 230 to one or more services implemented by service providers 112. The network request 230 is processed to generate and return a reply 232 with surface layer data, route points that define a route, text directions for decisions at waypoints along the route, distances between waypoints along the route, and/or other map data included in the reply 232. The OS in turn conveys the reply 232 with the various map data as a reply 222 for handling via the map navigation tool 110. The map data may be stored within the map data store 204 and/or communicated directly to the navigation engine 202 or analytics module 206.

As another example, as a user travels along a route, the map navigation tool 110 gets additional map data from the map data store 204 for rendering. The map data store 204 may cache detailed map data for the vicinity of the current location, using such cached data to incrementally change the rendered views. The map navigation tool 110 can pre-fetch map data along the route, or part of the route. Thus, as the rendered map views are updated to account for changes to the current location, the map navigation tool 110 often updates the display without the delay of requesting/receiving new map data from a server. As needed, the map navigation tool 110 requests additional map data to render views.

The rendering module 216 processes the view position, location data and map data, and renders a view of the map via a user interface 111 or otherwise. Depending on the usage scenario, the rendering module 216 renders map data from local storage, map data from a network server, or a combination of map data from local storage and map data from a network server. In general, the rendering module 216 provides output commands for the rendered view to the device OS for output on via a display, speakers, and/or other output device. The map navigation tool 110 reacts to changes in the location of the computing device and/or user input that indicates a change in view position, a change in the top item in a list of directions for a route, or other changes. The rendered map view is updated based on the changes. POIs and other search results exposed in connection with a map view or particular query are also updated as the view changes. POIs shown via the map view may include items for user-specific collection. Different visual indicators may be used to represent and distinguish between different types of POIs shown in the map view. For example, items from user-specific collection may be visually distinguished from other POIs using designated icons, map pins, colors, labels, effects, and so forth. Results of a search may also be shown in a list of results using a results pane, a side bar, a pop-up window or other suitable user interface instrumentality.

Having considered an example environment, consider now a discussion of some example details of techniques for collection-based searches along a route in accordance with one or more implementations.

### Collection-Based Search Along a Route Details

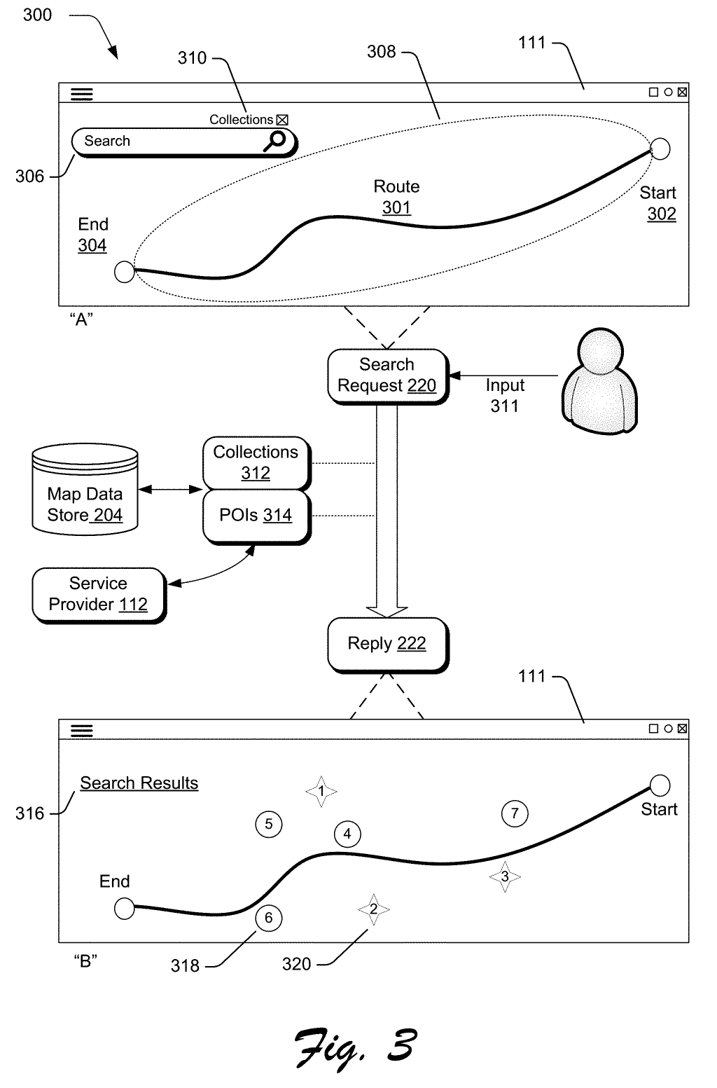

This section describes some example details in accordance with one or more implementations in relation to some example scenarios, procedures, and user interfaces of FIGS. 3-6. The procedures discussed below are represented as sets of blocks that specify operations performed by one or more devices and are not necessarily limited to the orders shown for performing the operations by the respective blocks. Aspects of the procedures may be implemented in hardware, firmware, or software, or a combination thereof Some aspects of the procedures may be implemented via one or more servers, such as via a service provider 112 that maintains and provides access to a search service 118, mapping service 120 and other resources 116. Aspects of the procedures may also be performed by a suitably configured device, such as the example computing device 102 of FIG. 1 that includes or makes use of a map navigation tool 110 and/or a client application module 108.

In general, functionality, features, and concepts described in relation to the examples above and below may be employed in the context of the example procedures described below. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

As noted, a map navigation tool 110 may be configured to conduct point-of-interest (POI) searches along a route in dependence upon information from collections associated with a user to inform the search results. In this context, FIG. 3 depicts generally at 300 an example scenario for a search along a route using user collections in accordance with one or more implementations. In general, the map navigation tool 110 may establish a route and present a map view of the route via a corresponding user interface 111. In the represented example, a view “A” shown in the user interface 111 depicts an example route 301 between a start 302 point and end 304 point. The view “A” represents a UI that may be rendered responsive to input obtained to define a route to display the route and provide navigational instructions to a user.

The map navigation tool 110, via the user interface 111 or otherwise, is further configured to include functionality to facilitate searches along the route and searches that rely upon user specific collections. A search may be initiated explicitly by a user using search tools exposed via the user interface 111, such as the example search control 306 represented in view “A”. In this approach, a user may enter particular search criteria, such as categories (e.g., park, restaurant, gas), specific place or business names, distance or time constraints, and so forth. A search to find POIs along a route may also occur automatically in response to input specifying the route, in which case the search occurs using pre-established selection criteria. In either case, searches along a route may utilize user-specific collections associated with the user in addition to or in lieu of using other global/public POI databases. The search may be constrained to an established search area associated with the route. For example, an example search area 308 may be established according to a predefined and/or configurable parameter that sets a distance or travel time from the route 301 to employ for the search. The parameter is used to compute a region around the route 301 to which the search is limited as represented by the example search area 308.

The system may be set-up to automatically access and use information from user-specific collections in connection with searches along a route. Use of user specific collections may be enabled by default and/or configurable settings may be provided to enable a user to specify whether or not collections are used, as well as to indicate whether the collections are used exclusively or in conjunction with other POI databases. A collection toggle 310 as shown in view “A” is representative of a control that may be used to adjust configurable settings for user specific collections. In this case, the collection toggle 310 is a check box that enables a selection to toggle use of collections on/off in relation to a search. Various other controls and corresponding settings are also contemplated, such as settings to specify a balance level between collections and other POIs, set weights for ranking of results, select/deselect particular collections or individuals/friends to include for searches, and so forth. Functionality to adjust various configurable settings may also be provided via a system or application level settings page and/or a settings dialog accessible via the user interface 111.

FIG. 3 further represents a scenario in which a point-of-interest (POI) search along a route is conducted in dependence upon information from collections. In particular, a search request 220 is obtained that specifies criteria for the search. The search request 220 may be formed according to input 311 from a user or alternatively may be generated automatically in response to input specifying a route. The search is conducted according to the criteria and a reply 222 is obtained in response to the search. As represented, the search may involve searching collections 312 associated with a user as well as other POIs 314 from global/public databases.

Collections 312 and other POIs 314 may be stored locally at a device, such as in a map data store 204. Collections 312 and other POIs 314 may also be accessed and downloaded from remote storage via a service provider 112. In implementations, collections 312 and other POIs 314 are maintained in the map data store 204 for fast access and may be periodically updated from online sources through interaction with one or more service providers.

Collection 312 represent various user-specific collections associated with a user. Collection 312 may include favorite items and lists that are shared between users in a social network setting. Sharing may be directly between individual users or through group interactions and lists. The user-specific collections may also include the user's own favorites items that the user published or shares with others. The map navigation tool 110 is configured to access and store data regarding shared items as collections in the map data store 204. The collections 312 may also include community-based collections (e.g., recommendation databases) that the user subscribes to or otherwise designates as collections to use to facilitate navigation and mapping activities. Community-based collections may be accessed from online databases and/or downloaded for storage in the map data store 204. Map data store 204 may maintain one or more collections 312 as structured data such as database records, formatted files, mark-up language documents, and so forth.

The reply 222 to a search includes information regarding items from the collections 312 and/or sources of other POIs 3124 that match the search criteria. Items may be provided in a raw format in which case, analytics module 206 associated with the map navigation tool 110 operates to process, rank, filter, and order the results according to designated selection criteria. Alternatively, the reply 222 may include formatted results that have already been pre-processed on the server side to rank, filter, and order the results. In any case, the reply 222 includes information sufficient to enable rendering a page showing search results 316, as represented by view “B.”

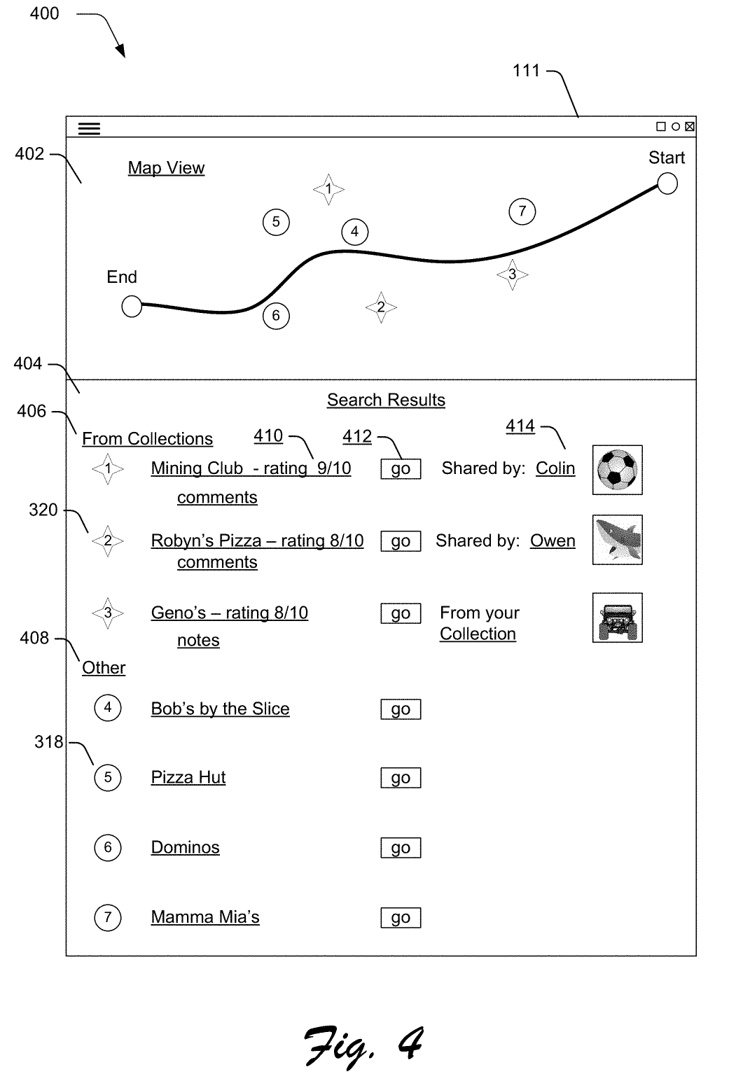

A variety of different configurations of a page having search results 316 are contemplated, examples of which are shown in FIGS. 3 and 4. For instance, the results may be showing as POIs in a map view as represented in view “B” of FIG. 3. Results may also be exposed as an ordered list of results with descriptions, links, images and other related information. Results may be exposed via different UI portions such as using pop-up boxes, different panes, a side bar element, and so forth.

In the example of view “B”, the map view includes visual indicators for the items returned as results and positioned at locations for the items on the map. Various visual indicators are contemplated such as pin elements, dots, stars, circles, icons, thumbnail images, arrows, or other graphical elements. Different indicators and styles may be employed to differentiate between different types or categories of items. In the depicted example, star indicators 320 are employed to represent items obtained from user-specific collections and circles are used to represent other POIs (e.g., POIs from sources other than the collections). In this way, a user can quickly recognize items along the route included in the user's collections. In implementations, the visual indicators are selectable to initiate actions related to associated items. By way of example, hovering a cursor near a visual indicator or clicking on the indicator may cause additional information regarding the item to appear via the UI. The additional information may include details of the location, distance away, timing indications, ratings, links, images, indications regarding who shared the item, information regarding a collection from which the item was obtained, a control operable to select the item, and so forth. Double clicking the indicators, selection of a control exposed upon hovering, pressing and holding on the indicator, or another defined selection of an item may be effective to cause modification of the route 301 to include a selected item as an intermediate point in the route.

FIG. 4 is a diagram depicting generally at 400 details of another example user interface presenting search results in accordance with one or more implementations. In this example, the user interface 111 is configured to include different regions or panes for a map view 402 and search results in a list view 404. The map view 402 provides a view of indicators for items along the route similar to view “B” discussed in relation to FIG. 3. The list view 404 provides a list of items returned in a reply 222 to a search request 220. The list view 404 generally includes a ranked and ordered list of results found to match the search criteria of a search. In the represented example, results of a search for “Pizza” along a route is depicted. The example search includes searching user-specific collections and accordingly the results include both items from collections and items from other sources. In this example, the list is separated into different sections including a section 406 for items from collections and a section 408 for other items not associated with a user-specific collection. Listed items may be listed with a description 410 providing a textual description of the item and a selection control 412 operable to select a corresponding item, such as the example “go” button. Selection of an item via the selection control 412 is effective to cause modification of the route to add the item as an intermediate point in the route. Items may also be listed with corresponding visual indicators, such as different indicators 318 and 320 discussed in relation to FIG. 3. For items associated with user specific collections, the list may provide various indications 414 identifying users/friends who shared particular items. Example indications 414 in FIG. 4 include a user name and icon shown in-line with listed items that were shared by others.

Although the example of FIG. 4 illustrated as a list separated into sections, the list may alternatively be configured as a combined list having items from collection interspersed with other items. Additionally, a search may be focused exclusively on user-specific collections, in which case the list may show just items from collection. On the other hand, if functionality to search collections is disabled or toggled off, the list and map will show just POIs from other sources. Additional details are discussed in relation to the following example procedures.

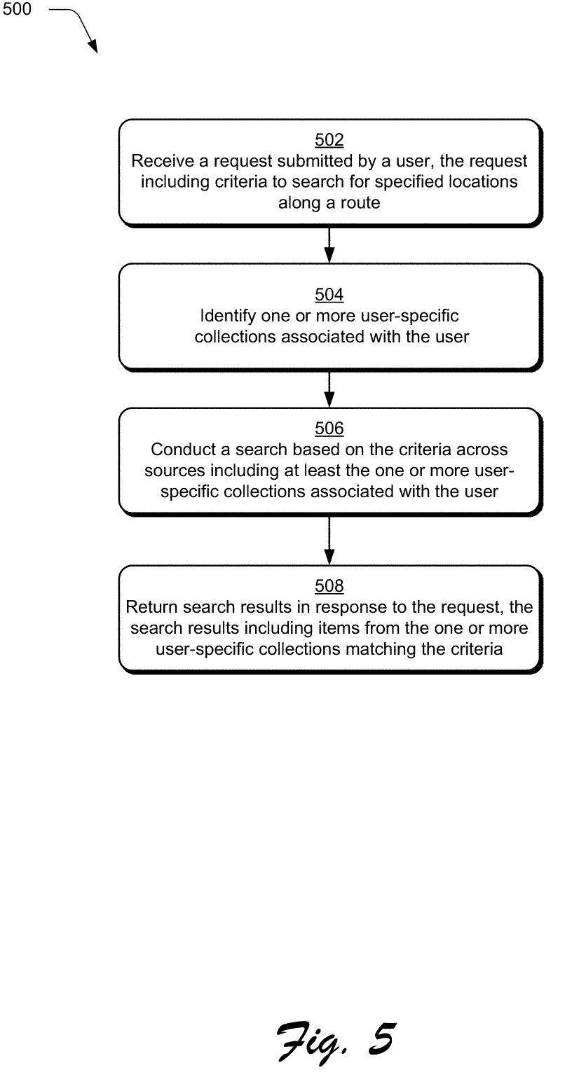

FIG. 5 is flow diagram depicting an example procedure 500 for a collection-based search in accordance with one or more implementations. A request submitted by a user is received, the request including criteria to search for specified locations along a route (block 502). For example, a search request 222 may be formed to define a search along a route. The request may specify various criteria such as location categories or specific location or business names. The request may also include selection parameters such as distance or time constraints. The request may additionally include indication regarding whether to use collections for the search and/or which collections to include in the search. While a user generated request is discussed, it is noted that a search to find POIs, and specifically to find POIs from collections, may alternatively occur automatically in response to input to create the route. In this case, default or pre-established criteria are used for the search. For instance, pre-established criteria may define a search in one or more commonly used categories and within a search area set according to a pre-defined distance from the route.

One or more user-specific collections associated with the user are identified (block 504). For instance, various user-specific collections may be associated with a user a described previously. The user-specific collections may be accessed and maintained via a map navigation tool 110. In an implementation, data for user-specific collections is stored as part of a map data store 204 that is integrated with or otherwise utilized by map navigation tool 110. Thus, the map navigation tool 110 may reference the map data store 204 to recognize user-specific collections corresponding to a user and/or determine which collection designated for use in connection with a search along a route.

A search based on the criteria is conducted across sources including at least the one or more user-specific collections associated with the user (block 506). In implementations, the system may be configured to focus the search using just the user-specific collections. In additionally or alternatively, the system may be configured to use other sources of POIs in combination with the user-specific collections. Application settings available for a map navigation tool 110 may be used to control the different sources and designate particular sources to include or exclude from searches.

Search results are returned in response to the request, the search results including items from the one or more user-specific collections matching the criteria (block 508). Here, the search is performed across different designated sources including one or more user-specific collections. The search involves finding items that match the specified criteria and generating a set of search results. The search results are sufficient to enable formation of a UI to display the results in various ways. By way of example and not limitation, search results may be presented in accordance with the example interfaces and details discussed in relation to FIGS. 3 and 4.

The search results may be returned as a ranked and ordered list of items that match the criteria. A visual presentation of the results may be generated in various UI views example of which include the map views and list views previously described. Visual indicators as previously described may be included in the views to show locations on a map and distinguish between different kinds of items using different indicators. Search results generally include a specified number of top ranking items (e.g., top 3 or 10 or 50). The number of items to return may be controlled based on a configurable parameter used to set the number of items. The ranking and ordering occurs based on a search algorithm designed to calculate scores indicative of the closeness of items to specified criteria. Items are ranked and ordered based upon the closeness scores computed for each item and other selection parameters such as distance or time constraints, user preferences, factors to promote particular items, and so forth.

In accordance with techniques described herein, the search algorithm may also be modified to favor items from collections by using an adjustment factor. The adjustment factor is a configurable parameter set to increase ranks/scores for collection items by a designated percentage or value. For example, the adjustment factor may be applied as a weight that boosts the scores for collection items used to rank and order results relative to scores for items from other sources. The adjustment factor/weight may be adjusted to different values with a designated range to tune the system. For example, the adjustment factor may be a multiplier selected between one and two that is applied to adjust scores for collection items. Selecting a multiplier of one results in no adjustment to computer scores, whereas selecting a multiplier of two would double scores for the collection items. Values between one and two result in corresponding adjustments. As noted, additional settings may be available to control whether collections are enabled/disabled, select collections to use on an individual basis, and indicate whether to focus a search just on designated collection or include other POI sources.

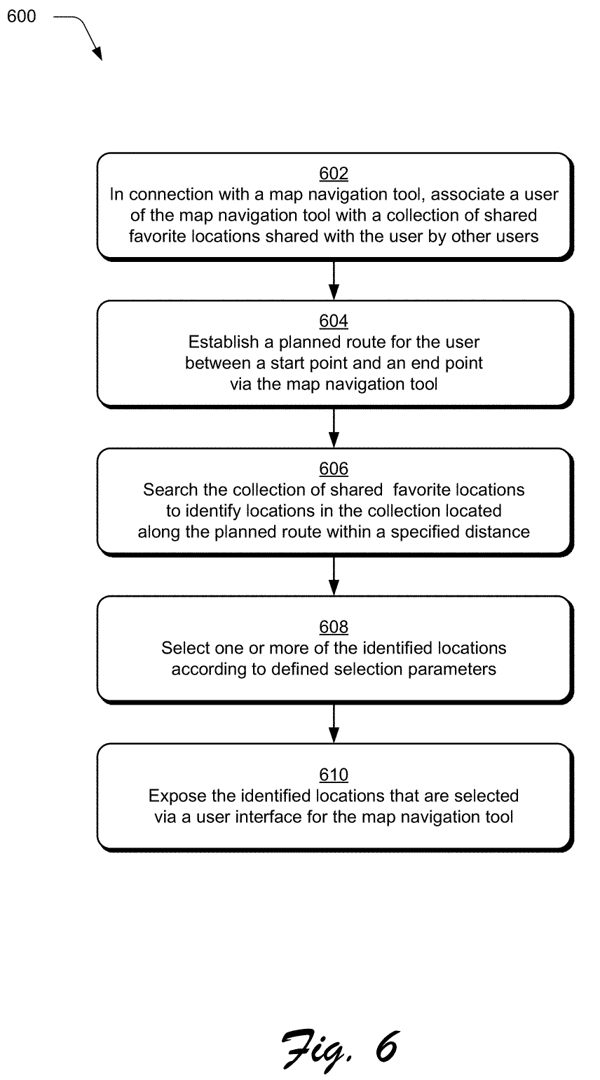

FIG. 6 is flow diagram depicting another example procedure 600 for a collection-based search in accordance with one or more implementations. In connection with a map navigation tool, a user of the map navigation tool is associated with a collection of shared favorite locations shared with the user by other users (block 602). Here, the search may be focused upon a collection(s) of favorite locations (e.g., POIs) that are shared between users. In implementations, locations may be shared through various social networking services that enable users to designate favorites or “like” particular items/places. Sharing may also occur via different types of communications such as email, text messaging, group forums, and so forth. A map navigation tool 110 may be configured to recognize items that are shared between users in various contexts and respond by collecting data indicative of the shared items and storing the data as user-specific collections. For example, the map navigation tool 110 may produce structured data defining the user-specific collections that is stored in a map data store 204 or otherwise. The structured data may be implemented in various ways including but not limited to database records, formatted files, mark-up language documents, and so forth.

A planned route for the user between a start point and an end point is established via the map navigation tool (block 604). Then, the collection of shared favorite locations is searched to identify locations in the collection located along the planned route within a specified distance (block 606). For example, a user may provide input to specify a planned route through interaction with the map navigation tool 110. A route may be designated by typing in a start and end point via a dialog exposed by the map navigation tool 110. Voice commands may also be used to specify a route through a digital assistant, by a voice command such as “Drive to Priest Lake, Id.” In another example, a route may be designated by touching or otherwise selecting points in a map view exposed by the map navigation tool 110. In response to suitable input to define a route, the map navigation tool 110 operates to calculate the route and/or prepare navigational instructions for the route. Various views of the route and information regarding the route may then be made available via a user interface 111 for the map navigation tool 110. In implementations, the user interface 111 is configured to implement functionality to enable searches along the route including searches that utilize user-specific collections. This functionality may include various controls and user interface instrumentalities operable to input a search request, such as the example search control 306 represented in FIG. 3. Additionally, functionality to enable searches along the route may include functionality to initiate a search automatically responsive to designation of the route (e.g., without explicit input of a search request).

The search is configured to find items that match criteria of the search such as locations that match place categories (e.g., gas, food, rest area) or specific names (e.g., McDonalds, Home Depot). In the context of a search along a route, criteria may also include a configurable parameter that sets a distance or travel time from the route to employ for the search. The parameter is used to compute a region around the route to which the search is limited. By way of example, the parameter may be configured to designated a specified distance such as one, five, or ten miles. The search is then limited to a region within the specified distance from points on the route. A comparable time factor such as five or ten minutes may be employed to control an amount of time it takes to deviate from the initial route to arrive at a POI. Limiting the search to the specified region may result in faster and more efficient searching relative to searching across an entire map view or geographic region.

Based on the search, one or more of the identified locations are selected according to defined selection parameters (block 608). For example, a set of search results that match the request criteria may be ranked and ordered based on the initial request criteria. The results may be further filtered and manipulated based on additional selection parameters such as adjustment factors for collection items or other weights for different types of items, distance or time constraints, a configurable parameter used to set the number of items to return, and so forth. In other words, the initial list of results may be refined to select a specified number of top items as results of the search. The identified locations that are selected are exposed via a user interface for the map navigation tool (block 610). Again, search results may be exposed in various ways using different views available via a map navigation tool 110, some examples of which were previously discussed in relation to the example interfaces and details of FIGS. 3 and 4.

Having described example procedures and details in accordance with one or more implementations, consider now a discussion of example systems and devices that can be utilized to implement the various techniques described herein.

### Example System and Device

FIG. 7 illustrates an example system generally at 700 that includes an example computing device 702 that is representative of one or more computing systems and/or devices that may implement the various techniques described herein. This is illustrated through inclusion of the map navigation tool 110, which operates as described above. The computing device 702 may be, for example, a server of a service provider, a device associated with a client (e.g., a client device), an on-chip system, and/or any other suitable computing device or computing system.

The example computing device 702 is illustrated as including a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### Example Implementations

Example implementations of techniques described herein include, but are not limited to, one or any combinations of one or more of the following examples:

### Example 1

A method implemented by a computing device comprising: receiving a request submitted by a user, the request including criteria to search for specified locations along a route; identifying one or more user-specific collections associated with the user; conducting a search based on the criteria across sources including at least the one or more user-specific collections associated with the user; and returning search results in response to the request, the search results including items from the one or more user-specific collections matching the criteria.

### Example 2

A method as recited in example 1, wherein the user-specific collections include lists of favorites items that are shared with the user by friends in a social network.

### Example 3

A method as recited in example 1, wherein the user-specific collections include group lists generated via social networks for groups to which the user belongs.

### Example 4

A method as recited in example 1, wherein the user-specific collections include community-based collections that the user designates as collections to include for searches along a route.

### Example 5

A method as recited in example 1, wherein conducting the search based on the criteria across sources comprises conducting the search across the one or more user-specific collections and one or more additional sources of points-of-interest (POIs).

### Example 6

A method as recited in example 1, wherein the search is focused exclusively upon the one or more user-specific collections associated with the user as the sources.

### Example 7

A method as recited in example 1, wherein returning the search results comprises generating and providing a ranked and ordered list of items that match the criteria according to a search algorithm.

### Example 8

A method as recited in example 7, wherein the search algorithm is modified to employ an adjustment factor that is applied to boost scores for items from user-specific collections used to rank and order results relative to scores for items from other sources.

### Example 9

A method as recited in example 1, further comprising rendering a view of the search results via a user interface for an application used to initiate the search, wherein the view includes at least one of: a map view depicting locations of the items included in the search results on a map along with a representation of the route, or a list view providing a ranked and ordered list of the items included in the search result.

### Example 10

A method as recited in example 1, wherein the method is implemented via a map navigation tool deployed on the computing device.

### Example 11

A method implemented by a computing device comprising: in connection with a map navigation tool, associating a user of the map navigation tool with a collection of shared favorite locations shared with the user by other users; establishing a planned route for the user between a start point and an end point via the map navigation tool; searching the collection of shared favorite locations to identify locations in the collection located along the planned route within a specified distance; selecting one or more of the identified locations according to defined selection parameters; and exposing the identified locations that are selected via a user interface for the map navigation tool.

### Example 12

A method as recited in example 11, wherein exposing the identified locations comprises showing the identified locations as point of interest (POIs) using visual indicators included in a map view of the route presented via the user interface for the map navigation tool.

### Example 13

A method as recited in example 12, wherein the visual indicators are selectable to cause modification of the route to include a selected one of the identified locations as an intermediate point in the route.

### Example 14

A method as recited in example 11, wherein exposing the identified locations comprises showing the identified locations in a ranked and ordered list of search results in a list view presented via the user interface for the map navigation tool.

### Example 15

A method as recited in example 11, further comprising: in addition to searching the collection of shared favorite locations, searching one or more additional sources of point of interest (POIs) to identify locations from the additional sources along the planned route, wherein results provided in response to the search include a combination of items from the collection of shared favorite locations and the additional sources.

### Example 16

A computing device comprising: a processing system; and one or more computer-readable storage media storing instructions that, when executed via the processing, implement a map navigation tool configured to perform operations to conduct a point-of-interest (POI) search along a route in dependence upon information from collections associated with a user, the operations including: deriving route points corresponding to a route established using the map navigation tool; conducting a search within a search region defined around the route points based on input search criteria; referencing one or more user-specific collections to identify items in the user-specific collections located along the route that match the search criteria; including items from the user-specific collections identified as matching the search criteria in search results returned as a reply for the search; and rendering a view of the search results via a user interface for the map navigation tool.

### Example 17

A computing device as recited in example 16, wherein the user-specific collections include lists of favorites items that are shared between users via social networks.

### Example 18

A computing device as recited in example 17, wherein the map navigation tool is further configured to perform operations including:

maintaining the user-specific collections in a map data store implemented by the map navigation tool.

### Example 19

A computing device as recited in example 18, wherein the map navigation tool is further configured to perform operations including: responsive to obtaining a selection via the user interface of a particular item contained in the view of the search results, modifying the route to include the particular item.

### Example 20

A computing device as recited in example 19, wherein the map navigation tool is further configured to perform operations including: providing navigation instructions via the user interface to guide a user along the route including navigation instructions to guide the user to a location for the particular item.

### CONCLUSION

Although techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method implemented by a computing device comprising:
receiving a request submitted by a user, the request including criteria to search for specified locations along a route;
identifying one or more user-specific collections associated with the user;
conducting a search based on the criteria across sources including at least the one or more user-specific collections associated with the user; and
returning search results in response to the request, the search results including items from the one or more user-specific collections matching the criteria.

2. A method as recited in claim 1, wherein the user-specific collections include lists of favorites items that are shared with the user by friends in a social network.

3. A method as recited in claim 1, wherein the user-specific collections include group lists generated via social networks for groups to which the user belongs.

4. A method as recited in claim 1, wherein the user-specific collections include community-based collections that the user designates as collections to include for searches along a route.

5. A method as recited in claim 1, wherein conducting the search based on the criteria across sources comprises conducting the search across the one or more user-specific collections and one or more additional sources of points-of-interest (POIs).

6. A method as recited in claim 1, wherein the search is focused exclusively upon the one or more user-specific collections associated with the user as the sources.

7. A method as recited in claim 1, wherein returning the search results comprises generating and providing a ranked and ordered list of items that match the criteria according to a search algorithm.

8. A method as recited in claim 7, wherein the search algorithm is modified to employ an adjustment factor that is applied to boost scores for items from user-specific collections used to rank and order results relative to scores for items from other sources.

9. A method as recited in claim 1, further comprising rendering a view of the search results via a user interface for an application used to initiate the search, wherein the view includes at least one of: a map view depicting locations of the items included in the search results on a map along with a representation of the route, or a list view providing a ranked and ordered list of the items included in the search result.

10. A method as recited in claim 1, wherein the method is implemented via a map navigation tool deployed on the computing device.

11. A method implemented by a computing device comprising:
in connection with a map navigation tool, associating a user of the map navigation tool with a collection of shared favorite locations shared with the user by other users;
establishing a planned route for the user between a start point and an end point via the map navigation tool;
searching the collection of shared favorite locations to identify locations in the collection located along the planned route within a specified distance;
selecting one or more of the identified locations according to defined selection parameters; and
exposing the identified locations that are selected via a user interface for the map navigation tool.

12. A method as recited in claim 11, wherein exposing the identified locations comprises showing the identified locations as point of interest (POIs) using visual indicators included in a map view of the route presented via the user interface for the map navigation tool.

13. A method as recited in claim 12, wherein the visual indicators are selectable to cause modification of the route to include a selected one of the identified locations as an intermediate point in the route.

14. A method as recited in claim 11, wherein exposing the identified locations comprises showing the identified locations in a ranked and ordered list of search results in a list view presented via the user interface for the map navigation tool.

15. A method as recited in claim 11, further comprising:
in addition to searching the collection of shared favorite locations, searching one or more additional sources of point of interest (POIs) to identify locations from the additional sources along the planned route, wherein results provided in response to the search include a combination of items from the collection of shared favorite locations and the additional sources.

16. A computing device comprising:
a processing system; and
one or more computer-readable storage media storing instructions that, when executed via the processing, implement a map navigation tool configured to perform operations to conduct a point-of-interest (POI) search along a route in dependence upon information from collections associated with a user, the operations including:
deriving route points corresponding to a route established using the map navigation tool;
conducting a search within a search region defined around the route points based on input search criteria;
referencing one or more user-specific collections to identify items in the user-specific collections located along the route that match the search criteria;
including items from the user-specific collections identified as matching the search criteria in search results returned as a reply for the search; and
rendering a view of the search results via a user interface for the map navigation tool.

17. A computing device as recited in claim 16, wherein the user-specific collections include lists of favorites items that are shared between users via social networks.

18. A computing device as recited in claim 17, wherein the map navigation tool is further configured to perform operations including:
maintaining the user-specific collections in a map data store implemented by the map navigation tool.

19. A computing device as recited in claim 18, wherein the map navigation tool is further configured to perform operations including:
responsive to obtaining a selection via the user interface of a particular item contained in the view of the search results, modifying the route to include the particular item.

20. A computing device as recited in claim 19, wherein the map navigation tool is further configured to perform operations including:
providing navigation instructions via the user interface to guide a user along the route including navigation instructions to guide the user to a location for the particular item.
